(19) United States
(12) Patent Application Publication
(10) Pub. No.: US 2024/0302077 A1
(43) Pub. Date: Sep. 12, 2024

(54) METHOD OF ARRANGING POSTS IN A SOLAR TRACKER

(71) Applicant: Gamechange Solar Corp., Norwalk, CT (US)

(72) Inventors: Andrew Barron Worden, Greenwich, CT (US); Scott Van Pelt, Tarrytown, NY (US); Anthony Assal, Jamaica, NY (US)

(73) Assignee: Gamechange Solar Corp., Norwalk, CT (US)

(21) Appl. No.: 18/586,445

(22) Filed: Feb. 24, 2024

Related U.S. Application Data
(60) Provisional application No. 63/447,914, filed on Feb. 24, 2023.

(51) Int. Cl. F24S 30/425; F24S 50/20; H02S 20/32

(52) U.S. Cl. CPC F24S 30/425; H02S 20/32; F24S 2050/25

(57) ABSTRACT

A method of determining post elevations in a single axis solar tracker that includes a tracker row with a plurality of posts, comprises providing location data (X, Y) in a plane for each of the plurality of posts in the row, and for each of the plurality of posts in the tracker row providing elevation data (Z) indicative of post elevation with respect to the plane. The method automatically generates nonlinear curve fit data that assigns initial post elevation values for each of the plurality of posts in the tracker row. For each of the plurality of post locations in the tracker row, the method automatically compares the initial post elevation values against a numerical constraint, and assigns a new initial post elevation value if the numerical constraint is violated. This method reduces the quantity of grading or extra support lengths needed to accommodate undulation of the terrain. The method may also use an iterative approach without using a curve fit.

### CROSS REFERENCE TO RELATED APPLICATIONS

This application claims the benefit of U.S. Provisional Patent Application Ser. No. 63/447,914 filed Feb. 24, 2023, which is hereby incorporated by reference.

### BACKGROUND OF THE INVENTION

### 1. Technical Field

This disclosure relates generally to solar trackers, and, more particularly, to a method of determining post elevations in a solar tracker that includes a tracker row with a plurality of posts.

### 2. Background Information

The number of utility-scale solar tracker systems is growing rapidly worldwide. While flat parcels of land are preferred for the trackers, such parcels are not always available. As a result, utility-scale solar tracker providers are providing systems that are suitable for parcels located on sloped terrain. Determining the height of each ground mounted tracker post on the sloped terrain is important to ensure torque tube slope changes in the row are acceptable while following the terrain.

There is a need for an improved method of determining post elevations in a single axis solar tracker that includes a tracker row with a plurality of posts in order to reduce the quantity of grading or extra support lengths needed to accommodate undulation of the terrain.

### BRIEF DESCRIPTION OF THE DRAWINGS

FIG. 1 illustrates a flow chart of a method of arranging posts in a solar tracker;

FIG. 2 is a graph of post height versus position for a row of posts showing a maximum post height, a minimum post height, an initial curve fit and a constrained curve fit; and

FIG. 3 illustrates a flow chart of a second method of arranging posts in a solar tracker.

### SUMMARY OF THE DISCLOSURE

According to an aspect of the disclosure, a method of determining post elevations in a single axis solar tracker that includes a tracker row with a plurality of posts includes providing location data (X, Y) in a plane for each of the plurality of posts in the row, and for each of the plurality of posts in the tracker row providing elevation data (Z) indicative of post elevation with respect to the plane; automatically generating nonlinear curve fit data that assigns initial post elevation values for each of the plurality of posts in the tracker row; and for each of the plurality of post locations in the tracker row, automatically comparing the initial post elevation values against a numerical constraint, and automatically assigning a new initial post elevation value if the numerical constraint is violated.

The step of automatically comparing the initial post elevation values against a numerical constraint may include comparing the initial post elevation values against minimum post height value and a maximum post height value.

The step of automatically comparing the initial post elevation values against a numerical constraint may include comparing the initial post elevation values to determine if change in post height in the row exceeds a slope limit.

According to another aspect of the disclosure, a method of determining post elevations in a single axis solar tracker that includes a tracker row with a plurality of posts includes providing location data (X, Y) in a plane for each of the plurality of posts in the row, and for each of the plurality of posts in the tracker row providing elevation data (Z) indicative of post elevation with respect to the plane; generating nonlinear curve fit data that assigns initial post elevation values for each of the plurality of posts in the tracker row; for each of the plurality of post locations in the tracker row, comparing the initial post elevation values against a minimum allowable post height and a maximum allowable post height, and for any of the initial post elevation values the outside of an acceptable range between the minimum and maximum allowable post heights, assigning a new initial post elevation value that is within the minimum and maximum allowable post heights; for each adjacent pair of plurality of posts in the tracker row in the nonlinear curve fit data, calculating an adjacent post slope value; comparing each of the adjacent post slope values against a first slope limit value; for each adjacent pair of plurality of posts along the length of the tracker row in the non-linear curve fit having a slope value that exceeds the first slope limit value, adjusting the assigned elevation for at least one of the plurality of posts in the adjacent pair of plurality of posts to order reduce the associated adjacent post slope value such that the adjacent post value is less than the first slope limit value, and less than the first slope limit value for each of the adjacent pair of plurality of posts.

The method may also include for each non-center post in the tracker row in the nonlinear curve fit, calculating a center post slope value indicative of slope running from the center post height in the tracker row to the associated non-center post height in the tracker row; and for each center post slope value greater than a second slope limit value, automatically assigning a new initial post evaluation value for the associated non-center post in the tracker row to reduce the associated center post slope value such that the center post slope value is less than the second slope limit value.

According to yet another aspect of the disclosure, a method of determining post elevations in a single axis solar tracker that includes a tracker row with a plurality of posts includes providing location data (X, Y) in a plane for each of the plurality of posts in the tracker row, and for each of the plurality of posts in the tracker row providing elevation data (Z) indicative of post elevation with respect to the plane; generating nonlinear curve fit data that assigns initial post elevation values for each of the plurality of posts in the tracker row; generating nonlinear curve fit data that characterizes post elevations for each of the plurality of posts running in the tracker row; for each of a plurality of pairs of the plurality of posts in the tracker row in the nonlinear curve fit data, calculating a post slope value; comparing each of the post slope values against a first slope limit value; and for each of the plurality of pairs having a post slope value that exceeds the first slope limit value, adjusting the post elevation value elevation for at least one of the plurality of posts in the pair of posts to reduce the associated post slope value such that the post slope value is less than the first slope limit value.

For each non-center post in the tracker row in the nonlinear curve fit, the method may include calculating a center post slope value indicative of slope running from the center post in the tracker row to the associated non-center post in the tracker row; and for each center post slope value greater than a second slope limit value, automatically adjusting the post elevation of the associated non-center post in the tracker row to reduce the associated center post slope value such that the center post slope value is less than the second slope limit value.

According to a further aspect of the disclosure, a method of determining post elevations in a single axis solar tracker that includes a tracker row with a plurality of posts includes providing location data (X, Y) in a plane for each of the plurality of posts in the tracker row, and for each of the plurality of posts in the tracker row providing an associated proposed post elevation value indicative of proposed post elevation with respect to the plane; automatically generating line fit data and assigning fit proposed post elevation values from the line fit data for each of the plurality of posts in the row; for each post location under test, performing constraint testing that includes (a) automatically comparing the fit proposed post elevation value for the post location under test against a maximum post height value constraint, and automatically reducing the fit proposed post elevation value by a certain value and automatically assigning a new fit proposed post elevation value for the post location under test; (b) for the post location under test, (i) automatically determining a slope of elevation change to an adjacent post to automatically determine if the slope exceeds a first slope limit constraint, and (ii) automatically determining a global slope for the row based upon the fit proposed post elevation values from a datum post to automatically determine if a second slope limit constraint is exceeded; (c) if either of the first or second slope limit constraints is exceeded, returning the fit proposed post elevation value for the post location under test to its former value and if the post location under test is not the last post of the row then advancing the post location under test to the next post in the row and returning to the step of performing constraint testing; and (d) if the first and second slope limit constraints are not exceeded, automatically advancing the post location under test to the next post in the row and returning to the step of performing constraint testing.

The foregoing features and the operation of the invention will become more apparent in light of the following description and the accompanying drawings.

### DETAILED DESCRIPTION

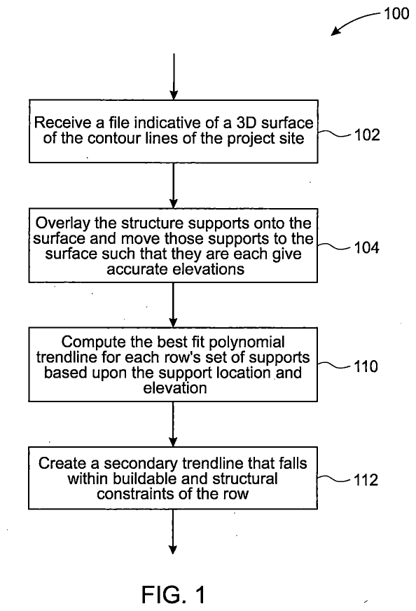

FIG. 1 illustrates a flow chart of a method 100 of arranging posts in a solar tracker. The method includes step 102 to receive a data file indicative of a 3D surface of the contour lines of the project site surface (i.e., the topography of the project site surface). The data may be in the form of a file, such as for example, a .dwg file, a .csv file, et cetera. In step 104, the method overlays vertical post/support data of a row onto the surface, such that initial post elevation data is provided indicative of the height of each post above a ground datum (e.g., above mean seal level (MSL)), along with the location along the ground of each post in the row. This post position and post height information may be provided as a three value cartesian coordinate such as (X, Y, Z), when X is the east-west position, Y is the north-south position and Z is the elevation of the post (e.g., the MSL of the top of the post). The method may be performed in a general purpose computer.

For each tracker row the cartesian coordinate value X for each post in the row is typically substantially the same if the rows extends in the north-south direction. In step 110 the method computes a preferred (e.g., a best) fit polynomial (e.g., a non-linear curve fit) trendline based upon the post ground location (e.g., cartesian coordinate values X and Y) and initial post elevation data (e.g., Z). Processing techniques to determine the preferred fit polynomial trendline may use tools such as, for example, the MATLABX processing system available from Mathworks, or Excel available from Microsoft, et cetera, to determine a second order or higher preferred fit indicative of the post elevation heights.

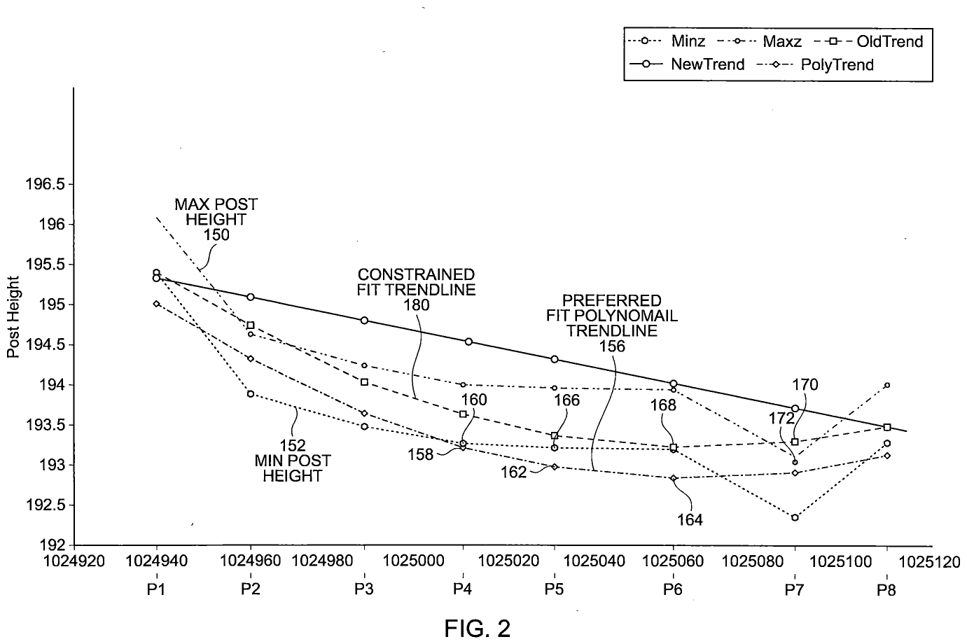

FIG. 2 is a graph of post height versus post positions P1-P8 in a tracker row, showing (i) a maximum post height based upon ground topography location, (ii) a minimum post height based upon ground topography location, and (iii) an initial preferred fit polynomial trendline and (iv) a constrained trendline. North-South position value of each post is plotted along the X axis of the graph illustrated in FIG. 2. This value is the Y value in the (X, Y) cartesian coordinate of the East-West (E-W) X value and the North-South (N-S) Y position. The X axis values may be distance along the ground from a datum position in the row and the Y axis values may be distance above mean sea level (MSL). Referring to still to FIG. 2, the graph also shows a linear curve fit line for comparative purposes.

Line 150 extends between maximum post height for each of the posts P1-P8 in the tracker row (e.g., a single axis tracker row). Line 152 extends between minimum post height for each of the posts P1-P8 in the row. While FIG. 2 illustrates eight maximum post heights plotted for eight posts (P1-P8) in the tracker row, it is contemplated that a row may have more or less than eight posts. In addition, while all the posts in the row may not be equidistantly spaced as shown in FIG. 1, it is contemplated that each of the posts may be equidistantly spaced.

Referring again to FIG. 1, in the step 110, for each tracker row the method computes a preferred (e.g., a best) fit polynomial trendline based upon the post location (e.g., X and Y) and the initial post elevation (e.g., Z) for each post location. Referring to FIG. 2, line 156 represents a preferred fit polynomial trendline determined by step 110 (FIG. 1) based upon the initial elevations for post P1-P8 locations plotted in FIG. 2. However, as show in FIG. 2 several of the preferred fit polynomial trendline post heights along the line 156 are less than the minimum allowable post heights plotted along line 152. For example, the post height at location P4 for the preferred fit line location 158 is slightly less than minimum allowable post height 160 for that post location. Similarly, at post locations P5, P6 the preferred fit line locations 162, 164 are less than the minimum allowable post heights 166, 168 respectively, for the associated post location. Finally, at post location P7 the preferred fit line identifies an elevation 170 for this post location that is greater than a maximum allowed post height 172 for that post location. Because several of the preferred fit post heights (e.g., 158, 162, 164 and 170) determined in step 110 are outside the range of allowable post heights, step 112 is performed to create a secondary/constrained trendline 180 that falls within buildable and structural constraints for post heights in the row.

Creating the secondary/constrained trendline in step 112 includes comparing the preferred fit polynomial post height data for each post from step 110, and if any of the post heights fall outside the minimum or maximum post height limits, the method updates the post height to be just within the acceptable range for that particular post location. However, this may result in the slope between the top of the adjacent posts being too large. In this case, step 112 may further process the post height data from step 110 to ensure that each post height is within the min and max allowable height for each post, and the slope between the tops of adjacent posts does not exceed a first slope limit. If the slope does exceed the first slope limit, then the post height for least one of the adjacent posts is adjusted to reduce the slope. Step 112 is then performed again to ensure this new proposed post height is between the minimum and maximum allowable height for the associated post locations, and the slope between adjacent posts does not exceed the first slope limit. If either the min/max test or the slope test fails, then steps 112 is performed yet again to reselect new post height(s) and the min/max height test and the slope test are performed again, resulting in the secondary/constrained trendline 180 that falls within buildable and structural constraints.

If the test of the slopes (i.e., the change in post height) between adjacent posts is less than the first slope limit value and heights for each post location is within the min/max for the post location, then a second test may be performed to test the slope over a longer length of the tracker row. For example, for this second slope test, the slope between each post and a datum post location (e.g., center post) in the row is assessed. If any of these slope values exceed a second slope limit, the method continues with step 112 to reselect post heights that allow the resultant row to pass the minimum and maximum post height tests, the slope test between adjacent posts and the slope test between the datum post and each post in the row. Steps 110 and 112 continue to be performed until the heights for each post in the tracker row satisfies the applicable constraints, such as for example the min and max tests and slope tests.

It is contemplated that other post height constraints may also be applied in the step 112 (FIG. 1) to ensure the second/constrained trendline 180 (FIG. 2) falls within buildable and structural constraints.

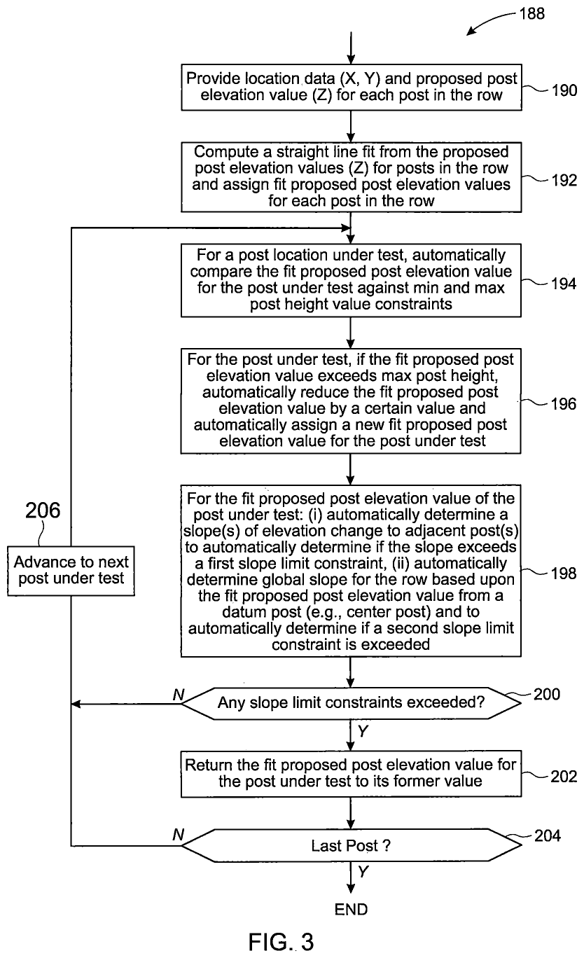

FIG. 3 illustrates a flow chart of a second method 188 of arranging posts in a solar tracker. In this exemplary embodiment, the method determines post elevations in a single axis solar tracker that includes a tracker row with a plurality of posts, using an iterative technique of adjusting post heights if post height constraints are violated, or row slope constraints are violated. The method 188 is performed in a general-purpose computer.

Referring to FIG. 3, in step 190 the method receives location data (X, Y) in a plane for each of the plurality of posts in the tracker row, and for each of the plurality of posts in the tracker row an associated proposed post elevation value (Z) is provided indicative of proposed post elevation with respect to the plane.

In step 192, the method computes a straight line fit from the proposed post elevation values (Z) for posts in the row and assigns fit proposed post elevation values for each post in the row.

In step 194, for a post location under test from the plurality of post locations in the tracker row, the method 188 automatically compares the fit proposed post elevation value for the post location under test against a maximum post height value constraint. Step 196 automatically reduces the fit proposed post elevation value for the post location under test by a certain value and automatically assigns a new fit proposed post elevation value for the post location under test if the maximum post height value constraint is exceeded.

In step 198, for the fit proposed post elevation value of the post location under test, the method 188 automatically determines a slope(s) of elevation change between the post location under test and adjacent post(s) in the row to automatically determine if the slope exceeds a first slope limit constraint. The step 198 also automatically determines a global slope for the row based upon the fit proposed post elevation value from a datum post (e.g., center post) and automatically determines if the global slope exceeds a second slope limit constraint.

In step 200, if either of the first or second slope limit constraints in step 198 are exceeded, then in step 202 the method 188 automatically returns the fit proposed post elevation value for the post location under test to its former value. Step 204 then tests if the post location under test is the last post in the row to be tested, and if not, then step 206 advances the post location under test to the next post in the row and returns to the step 194 to repeat the constraint testing in the step 194-198 again. In the step 200, if the first and second slope limit constraints are not exceeded, then in the step 206 the post location under test is advanced to the next post in the row and the method returns to the step 194 to repeat constraint testing in the step 194-198.

It is contemplated that method may be used in a tracker and fixed tilt system. In addition, while a straight-line fit is used to determine initial fit proposed post elevation values, other linear and non-linear fit techniques may be used.

The method allows a designer to start with a straight-line fit and curve it until it reaches a constraint.

While various embodiments have been disclosed, it will be apparent to those of ordinary skill in the art that many more embodiments and implementations are possible. For example, as described herein includes several aspects and embodiments each include particular features. Although these features may be described individually, it is within the scope of this disclosure that some or all of these features may be combined with any one of the aspects and remain within the spirit and scope of the invention. Accordingly, the present invention is not to be restricted except in light of the attached claims and their equivalents.

What is claimed is:

1. A method of determining post elevations in a single axis solar tracker that includes a tracker row with a plurality of posts, the method comprising:
providing location data (X, Y) in a plane for each of the plurality of posts in the row, and for each of the plurality of posts in the tracker row providing elevation data (Z) indicative of post elevation with respect to the plane;
automatically generating nonlinear curve fit data that assigns initial post elevation values for each of the plurality of posts in the tracker row; and
for each of the plurality of post locations in the tracker row, automatically comparing the initial post elevation values against a numerical constraint, and automatically assigning a new initial post elevation value if the numerical constraint is violated.

2. The method of claim 1, where the step of automatically comparing the initial post elevation values against a numerical constraint comprises comparing the initial post elevation values against minimum post height value and a maximum post height value.

3. The method of claim 1, where the step of automatically comparing the initial post elevation values against a numerical constraint comprises comparing the initial post elevation values to determine if change in post height in the row exceeds a slope limit.

4. A method of determining post elevations in a single axis solar tracker that includes a tracker row with a plurality of posts, the method comprising:
providing location data (X, Y) in a plane for each of the plurality of posts in the row, and for each of the plurality of posts in the tracker row providing elevation data (Z) indicative of post elevation with respect to the plane;
generating nonlinear curve fit data that assigns initial post elevation values for each of the plurality of posts in the tracker row;
for each of the plurality of post locations in the tracker row, comparing the initial post elevation values against a minimum allowable post height and a maximum allowable post height, and for any of the initial post elevation values the outside of an acceptable range between the minimum and maximum allowable post heights, assigning a new initial post elevation value that is within the minimum and maximum allowable post heights;
for each adjacent pair of plurality of posts in the tracker row in the nonlinear curve fit data, calculating an adjacent post slope value;
comparing each of the adjacent post slope values against a first slope limit value;
for each adjacent pair of plurality of posts along the length of the tracker row in the non-linear curve fit having a slope value that exceeds the first slope limit value, adjusting the assigned elevation for at least one of the plurality of posts in the adjacent pair of plurality of posts to order reduce the associated adjacent post slope value such that the adjacent post value is less than the first slope limit value, and less than the first slope limit value for each of the adjacent pair of plurality of posts.

5. The method of claim 4, further comprising:
for each non-center post in the tracker row in the nonlinear curve fit, calculating a center post slope value indicative of slope running from the center post height in the tracker row to the associated non-center post height in the tracker row; and
for each center post slope value greater than a second slope limit value, automatically assigning a new initial post evaluation value for the associated non-center post in the tracker row to reduce the associated center post slope value such that the center post slope value is less than the second slope limit value.

6. A method of determining post elevations in a single axis solar tracker that includes a tracker row with a plurality of posts, the method comprising:
providing location data (X, Y) in a plane for each of the plurality of posts in the tracker row, and for each of the plurality of posts in the tracker row providing elevation data (Z) indicative of post elevation with respect to the plane;
generating nonlinear curve fit data that assigns initial post elevation values for each of the plurality of posts in the tracker row;
generating nonlinear curve fit data that characterizes post elevations for each of the plurality of posts running in the tracker row;
for each of a plurality of pairs of the plurality of posts in the tracker row in the nonlinear curve fit data, calculating a post slope value;
comparing each of the post slope values against a first slope limit value;
for each of the plurality of pairs having a post slope value that exceeds the first slope limit value, adjusting the post elevation value elevation for at least one of the plurality of posts in the pair of posts to reduce the associated post slope value such that the post slope value is less than the first slope limit value.

7. The method of claim 6, where for each non-center post in the tracker row in the nonlinear curve fit, calculating a center post slope value indicative of slope running from the center post in the tracker row to the associated non-center post in the tracker row; and
for each center post slope value greater than a second slope limit value, automatically adjusting the post elevation of the associated non-center post in the tracker row to reduce the associated center post slope value such that the center post slope value is less than the second slope limit value.

8. A method of determining post elevations in a single axis solar tracker that includes a tracker row with a plurality of posts, the method comprising:
providing location data (X, Y) in a plane for each of the plurality of posts in the tracker row, and for each of the plurality of posts in the tracker row providing an associated proposed post elevation value indicative of proposed post elevation with respect to the plane;
automatically generating line fit data and assigning fit proposed post elevation values from the line fit data for each of the plurality of posts in the row;
for each post location under test, performing constraint testing that comprises
i. automatically comparing the fit proposed post elevation value for the post location under test against a maximum post height value constraint, and automatically reducing the fit proposed post elevation value by a certain value and automatically assigning a new fit proposed post elevation value for the post location under test;
ii. for the post location under test, (I) automatically determining a slope of elevation change to an adjacent post to automatically determine if the slope exceeds a first slope limit constraint, and (ii) automatically determining a global slope for the row based upon the fit proposed post elevation values from a datum post to automatically determine if a second slope limit constraint is exceeded;
iii. if either of the first or second slope limit constraints is exceeded, returning the fit proposed post elevation value for the post location under test to its former value and if the post location under test is not the last post of the row then advancing the post location under test to the next post in the row and returning to the step of performing constraint testing; and
iv. if the first and second slope limit constraints are not exceeded, automatically advancing the post location under test to the next post in the row and returning to the step of performing constraint testing.
